(19) United States
(12) Patent Application Publication
(10) Pub. No.: US 2021/0283578 A1
(43) Pub. Date: Sep. 16, 2021

(54) MESOPOROUS TRIAZOLE AND UREA BASED CARBON NITRIDE MATERIAL

(71) Applicant: SABIC Global Technologies B.V.

(72) Inventors: Ajayan Vinu, Mawson Lakes (AU); Gurudas P. Mane, Mawson Lakes (AU); Ugo Ravon, Thuwal (SA); Khalid Albahily, Thuwal (SA)

(21) Appl. No.: 16/324,950

(22) PCT Filed: Aug. 18, 2017
(86) PCT No.: PCT/IB2017/055012

§ 371 Date: Feb. 12, 2019

(51) Int. Cl. B01J 20/28; B01J 20/02; B01J 20/30; B01J 27/24; B01J 35/04; B01J 35/10; B01J 37/06; B01J 37/08; C01B 21/06

(52) U.S. Cl. CPC B01J 20/28083; B01J 20/0259; B01J 20/28061; B01J 20/3078; B01J 27/24; C01B 21/0605; B01J 35/1019; B01J 35/1061; B01J 35/1042; B01J 37/06; B01J 37/082; B01J 35/04

(57) ABSTRACT

Carbon nitride materials and method of making said carbon nitride materials is described. The carbon nitride materials can be a three dimensional C₃N₅ 3-amino-1,2,4,-triazole and urea based mesoporous carbon nitride matrix having an atomic carbon to nitrogen ratio of 0.55 to 0.8 and basic nitrogen containing groups of between 0.15 to 0.25 mmol per gram.

### CROSS-REFERENCE TO RELATED APPLICATIONS

This application claims the benefit of priority of U.S. Provisional Patent Application No. 62/377,793 filed Aug. 22, 2016, which is hereby incorporated by reference in its entirety.

### BACKGROUND

### 1. Field of the Invention

The invention generally concerns a three-dimensional nitrogen rich mesoporous material having a general formula of C₃N₅. In particular, the invention concerns a nitrogen rich mesoporous that includes a three dimensional C₃N₅ 3-amino-1,2,4,-triazole and urea based mesoporous carbon nitride matrix having an atomic carbon to nitrogen ratio of 0.55 to 0.8 and basic nitrogen containing groups of between 0.15 to 0.25 mmol per gram.

### 2. Description of Related Art

Due to its multiple surface functionalities and basic sites, carbon nitrides materials can be used for CO₂ activation. However due to the reduced numbers and accessibility to the N—H functionality of carbon materials responsible for activation, the development of a carbon nitride material with increased numbers of active sites is of interest. By way of example, Su et al. (Cat. Sci, & Tech., 2014, Vol 4, (6), pp. 1556-1562) describes urea-derived graphitic carbon nitride (u-g-C₃N₄) materials for CO₂ conversion into cyclic carbonates. These catalyst were prepared at different temperatures via a one-step polymerization/carbonization of urea. In another example, Shcherbana et al. (J. Indus. & Eng. Chem., 2016, Vol 34, pp. 292-299) describes a comparison study for the composition and sorption properties of different N-doped carbons prepared using ethylene diamine and carbon tetrachloride as nitrogen and carbon sources. In yet another example, Vinu et al. (RSC. Adv., 2015, Vol 5, (50), pp. 40183-40192) describes the synthesis of highly ordered MCNs with a high nitrogen content and controlled morphology using SBA-15 silica materials as templates and ethylene diamine and carbon tetrachloride as the nitrogen and carbon sources, respectively.

Many of the aforementioned catalysts suffer in that they have limited surface area and chemical reactivity due to lack of significant and accessible N—H bonds. These deficiencies make the catalysts inefficient for CO₂ activation.

### SUMMARY

A discovery has been made that addresses the problems associated with carbon nitride materials used for CO₂ activation and/or sequestration. The discovery is premised on the preparation of a nitrogen rich mesoporous material that includes a three dimensional (3D) C₃N₅, 3-amino-1,2,4-triazole (3-AT) and urea based mesoporous carbon nitride matrix having a range of unique and beneficial properties that are tunable according to the reactions conditions employed. These properties include an atomic carbon to nitrogen (C:N) ratio of 0.55 to 0.8, basic nitrogen containing groups of between 0.15 to 0.25 mmol per gram, a surface area of 170 to 250 m²/g, a pore volume of 0.2 to 0.4 cm³g⁻¹, a pore size of 2 to 5 nm, or any combination thereof. Further characterization of the mesoporous material shows a highly basic, well ordered, 3D-cubic Ia3d symmetric mesoporous carbon nitride with graphitic pore walls and very high nitrogen content. Without wishing to be bound by theory, the combination of these properties along with facile preparation from inexpensive and nontoxic precursors makes the current mesoporous material suitable for a wide range of applications (i.e. CO₂ activation, absorption of bulky molecules, catalysis, light emitting devices, photocatalytic water splitting, as a storage material, sensing device, solar cells, etc.). Notably, the mesoporous material of the current invention is an excellent catalyst for CO₂ activation and/or sequestration. Enhanced activation or adsorption of CO₂ is due to the accessibility of the CO₂ to and NH₂ species in the mesoporous material. The triazole urea connection provides a greater number of NH and NH₂ species as compared to other triazole-amine compounds (e.g., ethylene diamine).

In a particular embodiment of the current invention, a mesoporous carbon nitride (CN) material is described. The mesoporous CN material can include a three dimensional C₃N₅ mesoporous carbon nitride polymeric material, said polymeric material can include monomeric units of 3-amino-1,2,4-triazole and urea, an atomic carbon to nitrogen ratio of 0.55 to 0.8, and basic nitrogen containing groups of between 0.15 to 0.25 mmol per gram. Also described is a mesoporous carbon nitride (CN) material including a three dimensional C₃N₅ mesoporous carbon nitride material formed by polymerization of 3-amino-1,2,4-triazole and urea having an atomic carbon to nitrogen ratio of 0.55 to 0.8 and basic nitrogen containing groups of between 0.15 to 0.25 mmol per gram. In one aspect, the surface basicity of the mesoporous CN material can be about 0.20 mmol per gram and the carbon to nitrogen ratio can be about 0.70. In certain aspects, the material can include at least 50% nitrogen and can have an average pore diameter of 2 to 5 nm. In other aspects, the mesoporous CN material can have a surface area of 170 to 250 m²/g, a pore volume of 0.2 to 0.4 cm³g⁻¹, or any combination thereof. Notably, the material can be used as CO₂ activation catalyst.

According to another particular embodiment of the current invention, a process for CO₂ sequestration is described. The process can include (a) contacting the mesoporous CN material with a feed stock comprising CO₂ to form a reactant mixture; and (b) incubating the reactant mixture under conditions in which CO₂ is attached to the mesoporous CN material. The attached CO₂ can be activated, undergo reaction, and be released to regenerate the mesoporous CN material. In some instances, the mesoporous CN material regenerated for example, by a pressure swing adsorption (PSA) process at a lower pressure and/or a using a change of feed material. In one aspect, the CO₂ can be reacted with another compound to produce acid, aldehyde, ketone, or alcohol. In another aspect, the feedstock can be a gas effluent from a CO₂ producing process, such as a flue gas emission from a power plant.

In other embodiments, a method of producing a mesoporous CN material of the current invention is described. The method can include (a) mixing a hard template with equimolar amounts of 3-amino-1,2,4-triazole and urea (TU) in an acidic aqueous solution forming a template reactant mixture; (b) heating the template reactant mixture to form a TU/template composite; (c) heating treating the TU/template composite to a temperature of 450 to 550° C. to form a cubic mesoporous carbon nitride material/template (MCN-TU/template complex; and (d) removing (e.g., dissolving) the template from the cubic mesoporous carbon nitride material/template complex producing a three dimensional C₃N₅ mesoporous carbon nitride material having an atomic carbon to nitrogen ratio of 0.55 to 0.8 and basic nitrogen containing groups of between 0.15 to 0.25 mmol per gram. In one aspect, the heating of step (b) includes heating to a first temperature of 90 to 110° C., preferably about 100° C. for 4 to 8 hours, preferably, 6 hours; and increasing the temperature to 150 to 170° C., preferably about 160° C. for 4 to 8 hours, preferably 6 hours. In some aspects, the heating of step (c) is about 500° C. In some instances, the MCN-TU/template complex can be heated under an inert gas atmosphere and the inert gas can be argon. In some embodiments, the hard template can be KIT-6, MCM-41, SBA-15, TUD-1, HMM-33, or mixtures thereof. In a preferred embodiment, the template is KIT-6. In another embodiment, there is also disclosed a method to prepare the KIT-6 template. The method can include (a) obtaining a polymerization solution comprising amphiphilic triblock copolymer and tetraethyl orthosilicate (TEOS); (b) reacting the polymerization mixture at a predetermined reaction temperature to form a KIT-6 template; (c) drying the KIT-6 template at 90° C. to 110° C., preferably; and (d) calcining the dried KIT-6 template in air at 500 to 600° C., preferably 540° C. to form a calcined KIT-6 template. The predetermined temperature in step (b) can used to tune the pore size of the KIT-6 template. In a particular aspect, the polymerization mixture can be held (incubated) at a synthesis temperature of about 100 to 200° C., preferably 150° C.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The following includes definitions of various terms and phrases used throughout this specification.

The phrase “nitrogen rich” refers to carbon nitrides having more nitrogen atoms than graphitic carbon nitrides having the general formula of C₃N₄.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value. In one non-limiting embodiment, the terms are defined to be within 10%, preferably within 5%, more preferably within 1%, and most preferably within 0.5%.

The use of the term “or” in the claims is used to mean “and/or” unless explicitly indicated to refer to alternatives only or the alternatives are mutually exclusive, although the disclosure supports a definition that refers to only alternatives and “and/or.”

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The carbon nitride materials of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the catalysts of the present invention are their abilities to activate and/or sequester CO₂.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein. The drawings may not be to scale.

FIG. 1 is a schematic representation for the preparation of 3-amino-1,2,4-triazole and urea based 3D cubic mesoporous carbon nitride (MCN-TU) of the present invention using KIT-6.

FIG. 2 is a schematic representation of the use of the MCN-TU material to capture CO₂.

FIG. 3 is a schematic representation of the use of the MCN-TU material to produce activated CO₂.

FIGS. 4 and 5 shows (4) low angle powder X-ray diffraction (XRD) pattern and (5) wide angle XRD pattern of mesoporous carbon nitride with various pore diameters prepared from KIT-6-x templates: MCN-TU-100 (bottom), (b) MCN-TU-130 (middle), and (c) MCN-TU-150 (top).

FIG. 6 shows (a) nitrogen adsorption-desorption isotherm and (b) BJH pore size distribution of the mesoporous carbon nitride materials prepared from KIT-6-x templates: MCN-TU-100 (circle); MCN-TU-130 (diamond); MCN-TN-150 (triangle)

FIG. 7 shows the Energy dispersive X-ray spectroscopy (EDX) spectrum of MCN-TU-150.

FIG. 8 shows High resolution transmission electron microscopy (HRTEM) images of MCN-TU-150.

FIG. 9 shows the Electron Energy Loss Spectrum (EELS) of MCN-TU-150 of the present invention.

FIG. 10 shows core level (a) C1s and (b) N1s X-ray photon spectroscopy (XPS) spectra of MCN-TU-150 of the present invention.

FIG. 11 shows Fourier transform infrared (FT-IR) spectra of the MCN-TU-150 of the present invention.

FIG. 12 shows the temperature programmed desorption (TPD) plot of carbon dioxide desorbed from the MCN-TU sample of the present invention.

FIG. 13 shows QCM frequency variation during the sensitivity measurement as a function of time for different analytes

FIG. 14 shows bar graphs depicting different frequency shifts to different vapors as detected by the QCM sensor.

### DETAILED DESCRIPTION

A discovery has been made that provides a mesoporous carbon nitride (CN) material having the appropriate characteristics for a range of applications (i.e. CO₂ activation, sequestration, and molecular sensing). The discovery is premised on a preparation method that provides a nitrogen rich three dimensional C₃N₅ 3-amino-1,2,4,-triazole and urea based mesoporous carbon nitride matrix that offers increased accessibility and numbers of pores containing reactive functionality useful for CO₂ activation and/or sequestration. In certain aspects, the tuning of the mesoporous CN material can be accomplished by controlling the pore size and other dimensions of the mesoporous CN material.

These and other non-limiting aspects of the present invention are discussed in further detail in the following sections with reference to the Figures.

### A. Mesoporous Carbon Nitride Materials

Certain embodiments are directed to a nitrogen rich mesoporous material based on 3-amino-1,2,4,-triazole and urea. Such a material can have a well ordered 3-D body-centered cubic structure that includes monomeric units of 3-amino-1,2,4-triazole and urea (designated as MCN-TU throughout the specification). This material can have a general formula of C₃N₅. In some embodiments, the carbon nitride material can be formed by polymerization of 3-amino-1,2,4-triazole with itself, urea with urea, 3-amino-1,2,4-triazole with urea, or combinations thereof. Notably, the MCN-TU material includes specific carbon to nitrogen ratios, amounts of basic nitrogen containing groups, and surface basicity. In particular aspects, the mesoporous material can have an atomic carbon to nitrogen (C:N) ratio of 0.5, 0.6, 0.7, 0.8 or greater than, equal to, or between any two of 0.55, 0.6, 0.65, 0.7, 0.75, and 0.8. In a preferred embodiment, the atomic C:N ratio is 0.6 to 0.8, or about 0.7. The atomic N:C ratio can be 1.25 to 1.8, or greater than, equal to, or between any two of 1.25, 1.30, 1.35, 1.40, 1.45, 1.50, 1.55, 1.60, 1.65, 1.7, 1.75 and 1.8. In a preferred embodiment, the atomic N:C ratio is 1.25 to 1.67, preferably 1.43. In other particular aspects, the MCN-TU material contains basic nitrogen containing groups of between 0.15 to 0.25 mmol per gram and all values there between (e.g., 0.16, 0.17, 0.18, 0.19, 0.20, 0.21, 0.22, 0.23, or 0.24 mmol per gram). The surface basicity can range from 0.1 to 0.3 mmol per gram and all value there between (e.g. 0.1, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, or 0.3 mmol per gram). Specifically, the surface basicity is about 0.20 mmol per gram. The MCN-TU material can include at least 10%, 15%, 20%, 25%, 30%, 35%, 40%, 45% or 50% elemental nitrogen (N). The MCN-TU can have a pore size or pore diameter of 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, or 30 nm. Specifically the pore size can range from 2 to 10 nm, preferably 2 to 5 nm. The pore volume of the mesoporous material can range from 0.2 to 0.4 cm³g⁻¹ or any value or range there between (e.g., 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, or 0.40 cm³g⁻¹). A surface area of the MCN-TU can be from 100 to 300 m²g⁻¹ or any range or value there between (e.g., 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 143, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 243, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, or 300 m²g⁻¹). Preferably, the surface area ranges from 150 to 300 m²g⁻¹ or from 170 to 250 m²g⁻¹. Without being limited by theory, the MCN-TU material of the present invention has highly basic characteristics that provide its unique and beneficial properties. The highly basicity can be attributed to the increased presence of primary and secondary amines (i.e., NH and NH₂) functionality on the surface of the MCN-TU material.

### B. Method of Making

The MCN-TU material can be formed by nanocasting using a template. Nanocasting is a technique to form periodic mesoporous framework using a hard template to produce a negative replica of the hard template structure. A molecular precursor can be infiltrated into the pores of the hard template and subsequently polymerized within the pores of the hard template at elevated temperatures. Then the hard template can be removed by a suitable method. This nanocasting route is advantageous because no cooperative assembly processes between the template and the precursors are required. A hard template can be a mesoporous silica. In one aspect, the mesoporous silica can be KIT-6, MCM-41, SBA-15, TUD-1, HMM-33, etc., or derivatives thereof prepared in similar manners from tetraethyl orthorsilicate (TEOS) or (3-mercaptopropyl) trimethoxysilane (MPTMS). In certain aspect, the mesoporous silica is a 3D-cubic Ia3d symmetric silica, such as KIT-6 which contains interpenetrating cylindrical pore systems. Highly ordered mesoporous silicas can be obtained under various conditions using inexpensive materials.

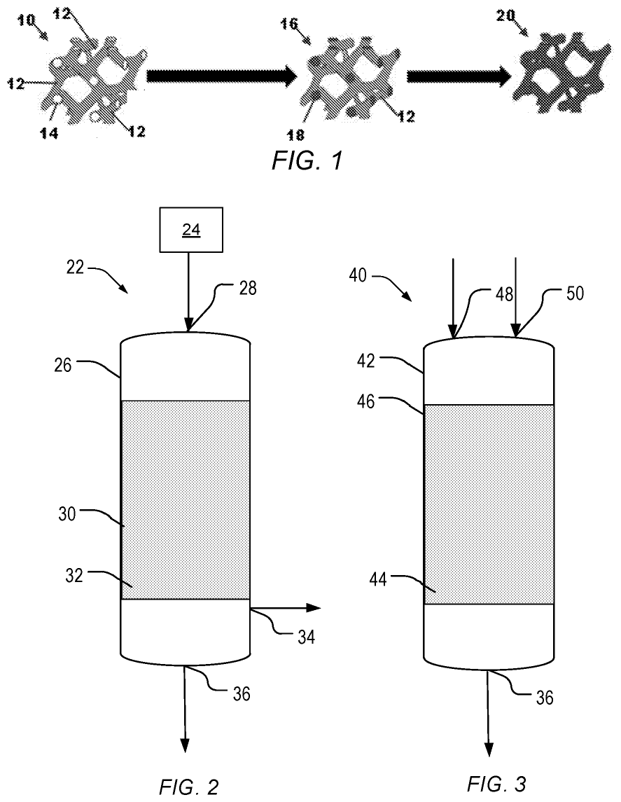

FIG. 1 is a schematic representation of one embodiment of a method for producing a MCN-TU (C₃N₆) material by using a hard templating approach, also called a replica approach, as described herein. Template 10 (e.g., calcined KIT-6) can include canal 12 and pores 14. Canal 12 is representative of the pore volume of template 10. Pores 14 can be filled corresponding carbon nitride precursor material 16 to form a template/carbon nitride precursor material. By way of example, an aqueous solution of 3-amino-1,2,4-triazole and urea can be added to a KIT-6. The template/carbon nitride precursor material can undergo a thermal treatment to polymerize the precursor inside the pore of the material to form template/CN composite 16 having canal 12 and polymerized CN material 18. Template/CN composite 16 can be subjected to conditions sufficient to remove the template 10 (e.g., KIT-6), and form the mesoporous carbon nitride material 20 of the present invention. By way of example, the template 10 can be dissolved using an HF treatment, a very high alkaline solution, or any other dissolution agent capable of removing the template and not dissolving the CN framework. The kind of template and the CN precursor used influence the characteristics of the final material. By way of example, various KIT-6 with various pore diameters can be used as templates. In certain aspects, the pore size of the KIT-6 template can be tuned and 3-amino-1,2,4-triazole and urea can be used to produce a high nitrogen content.

In one non-limiting embodiment, step one of a method to prepare a nitrogen rich mesoporous material can include obtaining an template reactant mixture including a calcined mesoporous KIT-6 template having a selected porosity, a protonated 3-amino-1,2,4-triazole and urea (TU). Preferably, the wt. % ratio of 3-amino-1,2,4-triazole, urea, KIT-6 template in the reactant mixture is about 3:3:1. In some instances, obtaining the template reactant mixture includes adding calcined KIT-6 to an aqueous solution of 3-amino-1,2,4-triazole, urea, and hydrochloric acid. In other instances, the template reactant mixture can be a gel. In step 2 of the method, the template reactant mixture can be heated to form a TU/KIT-6 composite. The heating of the template reactant mixture to form a composite can include heating to a first temperature of 90 to 110° C. or 95 to 105° C., or 100° C. for a desired amount of time (e.g., 4 to 8 hours or 5 to 7 hours, or 4, 5, 6, 7, or 8 hours) and then optionally increasing the temperature of the templating reactant mixture to a second temperature (e.g., 150 to 170° C., or 155 to 165° C., or 150° C., 155° C., 160° C., 165° C., or 170° C.) and holding (incubated) at the second temperature for a desired amount of time (e.g., 4 to 8 hours or 5 to 7 hours, or 4, 5, 6, 7, or 8 hours) to form an TU/KIT-6 composite. The step-wise heating can facilitate filling of pores of the KIT-6 material by the CN precursor gel to form a TU/KIT-6 composite. Step 3 of the method can include polymerization of the TU/KIT-6 composite. The TU/KIT-6 composite can be heated under a flow of inert atmosphere (e.g., argon, nitrogen, or mixtures thereof) to a temperature of 450 to 550° C., preferably about 500° C., for a period of time to form a cubic mesoporous carbon nitride material/KIT-6 complex (MCN-TU/KIT-6). In some aspects, the TU/KIT-6 composite can be heated under inert atmosphere gas flow to temperature at a rate of about 1, 2, 3, 4, 5, or 6° C. per minute. The inert atmosphere gas flow can be at about 50, 60, or 70 to 100, 120, or 150 ml per minute, including all values and ranges there between. The TU/KIT-6 composite can be incubated (held) at about 400 C°. In step 4 of the method, the KIT-6 can be removed by dissolving the KIT-6 template from the MCN-TU/KIT-6 complex to form the MCN-TU material of the present invention. In some aspects, hydrofluoric acid or other suitable solvent or treatment can be used that dissolves the KIT-6 without dissolving the CN framework. The method can further include collecting the cubic mesoporous carbon nitride material by filtration. In a further aspect the filtered material can be ground to a powder and/or purified and/or stored and/or used directly in subsequent applications (e.g., CO₂ capture, sensing applications, or CO₂ reactions).

In some aspects, the MCN-TU material can include a metal or metal alloy. The metal or metal alloys can be obtained from a variety of commercial sources in a variety of forms (e.g., particles, rods, films, etc.) and sizes (e.g., nano scale or micro scale). By way of example, each of Sigma-Aldrich® Co. LLC and Alfa Aesar GmbH & Co KG offer such products. Alternatively, the metal containing MCN-TU can be prepared using co-precipitation or deposition-precipitation methods. In some embodiments, the metal can be deposited on the MCN-TU material prior to or during a photochemical reaction. By way of example, a metal precursor (e.g., a metal nitrate or metal halide) can be added to an aqueous solution containing the MCN-TU material and a sacrificial agent. The metal salt can absorb on the surface of the MCN-TU material. Upon irradiation, the metal ions can be converted to the active metal species (e.g., zero valance).

A KIT-6 template can be produced by first obtaining a polymerization solution including an amphiphilic triblock copolymer dispersed in an aqueous hydrogen chloride solution with 1-butanol and tetraethyl orthosilicate (TEOS) to form a polymerization mixture. In a second step the polymerization mixture can be reacted by incubating at a predetermined synthesis temperature to form a KIT-6 template, wherein the predetermined temperature determines the pore size of the KIT-6 template. The polymerization mixture can be incubated at a synthesis temperature of about 100 to 200° C., or any value or range there between (e.g., 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 143, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, or 199° C.). For the general formula KIT-6-X, X represents the reaction temperature. For example, in certain aspects the polymerization mixture can be heated at a synthesis temperature of about 100, 130, or 150° C. to yield corresponding KIT-6 templates denoted KIT-6-100, KIT-6-130, KIT-6-150 respectively. Preferably, the reaction temperature is 100° C. The formed KIT-6 template can then be dried at 90° C. to 110° C., preferably 100° C. In a final step, the dried KIT-6 template can be calcined. Calcination includes heating the KIT-6 template to about 500° C. to 600° C. or any value or range there between (e.g., 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 543, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, or 600° C., preferably 540° C.) in air to decompose the triblock copolymer.

A non-limiting example of producing a KIT-6 template includes mixing Pluronic P-123 in aqueous HCl with stirring at 35° C. until dissolution. n-Butanol (1-butanol) can then be added with continued stirring and after 1 hour TEOS can be added and the resulting mixture can be vigorously stirred at 35° C. for 24 hours. The mixture can then be aged (incubated) at 150° C. for 24 h under static conditions and resulting colorless solid, and then be filtered at 50° C. or less without washing, and then dried in oven at 100° C. for 24 h and then calcined in air at 540° C.

### C. Use of the Mesoporous Carbon Nitride Materials

The three dimensional 3-amino-1,2,4-triazole and urea based mesoporous carbon nitride matrix material can be used in many applications, such as capture and activation CO₂, absorption of bulky molecules, catalysis, light emitting devices, as a storage material, sensing device, etc. Specifically, the mesoporous material of the current invention can be used to sequester and/or activate CO₂.

According to one embodiment of the present invention, a process for CO₂ capture is described. In step one of the process, a feed stock comprising CO₂ is contacted with MCN-TU to form a reactant mixture. The feed stock can include a concentration of CO₂ from 0.01 to 100% and all ranges and values there between (e.g., 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.22, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.50, 0.51, 0.52, 0.53, 0.54, 0.55, 0.56, 0.57, 0.58, 0.59, 0.60, 0.61, 0.62, 0.63, 0.64, 0.65, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100%). The % of CO₂ in the feed stock can be measured in wt. % or mol. % or volume % based on the total wt. % or mol. % or volume % of the feed stock respectively. In a preferred aspect, the feedstock can be ambient atmospheric or a gas effluent from a CO₂ producing process. In one non-limiting instance, the CO₂ can be obtained from a waste or recycle gas stream (e.g., a flue gas emission from a power plant on the same site such as from ammonia synthesis or a reverse water gas shift reaction) or after recovering the carbon dioxide from a gas stream. A benefit of recycling carbon dioxide as a starting material can reduce the amount of carbon dioxide emitted to the atmosphere (e.g., from a chemical production site). The feedstock containing CO₂ can contain additional gas and/or vapors (e.g., nitrogen (N₂), oxygen (O₂), argon (Ar), chloride (Cl₂), radon (Ra), xenon (Xe), methane (CH₄), ammonia (NH₃), carbon monoxide (CO), sulfur containing compounds (RₓS), volatile halocarbons (all permutations of HFCs, CFCs, and BFCs), ozone (O₃), partial oxidation products, etc.). In some examples, the remainder of the feedstock gas can include another gas or gases provided the gas or gases are inert to CO₂ capture and/or activation for further reaction so they do not negatively affect the reaction. In instances where another gas or vapors do have negative effects on the CO₂ capture process (e.g., conversion, yield, efficiency, etc.), those gases or vapors can be selectively removed by known processes. Preferably, the reactant mixture is highly pure and substantially devoid of water. In some embodiments, the CO₂ can be dried prior to use (e.g., pass through a drying media) or contain a minimal amount of water or no water at all. Water can be removed from the reactant gases with any suitable method known in the art (e.g., condensation, liquid/gas separation, etc.).

In a step 2 of the process, the reactant mixture is contacted with the MCN-TU material under conditions in which CO₂ is attached to the mesoporous material. For example, the CO₂ can be adsorbed by the mesoporous material or can covalently bind to a primary or secondary nitrogen group of the mesoporous material. The contact conditions can include a temperature, pressure, and time. The temperature range for the contacting can be from −10° C. to 500° C., from 0° C. to 350° C., 10° C. to 200° C., 15° C. to 150° C., 20° C. to 100° C. and all ranges and temperatures there between. The pressure range for contacting can be from 0.05 MPa to 0.5 MPa, or 0.1 to 0.2 MPa. In embodiments, where adsorption/desorption processes are used, the pressure of adsorption is higher than a pressure of desorption. By way of example, a gas including methane, hydrogen, or other less adsorbing gases, the adsorbing CO₂ partial pressure can range from 0.1 to 5.0 bar (0.01 to 0.05 MPa) and the desorbing CO₂ partial pressure can range from 0 bar to 5 bar (0 MPa to 0.5 MPa). The time of contact can be as long or as short as needed (e.g., from 1 sec to 60 seconds, 5 minutes to 50 minutes, 10 minutes to 30 minutes, or 1 hour or more). The conditions for CO₂ capture can be varied based on the source and composition of feed stream and/or the type of the reactor used.

According to another embodiment of the current invention, the MCN-TU material containing attached CO₂, the CO₂ can be released to regenerate the MCN-TU material and CO₂. In some embodiments, the bound CO₂ can be activated, undergo reaction, and the resulting reaction product can be released to regenerate the MCN-TU material. Without limitation, equilibrium binding between the MCN-TU material and CO₂ can occur. In some aspects, an equilibrium binding constant can be determined and influenced by typical reaction condition manipulations (e.g., increasing the concentration or pressure of the reactant feed stock, etc.). The methods and system disclosed herein also include the ability to regenerate used/deactivated catalyst in a continuous process. Non-limiting examples of regeneration include a pressure swing adsorption (PSA) process at a lower pressure and/or a using a change of feed material. In one aspect, the captured CO₂ can be activated, reduced and released as carbon monoxide (CO). In other aspects, the captured CO₂ can be activated, reacted in a substitution reaction, and be released as an acid. In further aspects, the activated CO₂ can provide a source of electrophilic oxygen to form epoxides, alcohols, aldehydes, ketones, carboxylic acids, and carbon monoxide. For example, activated CO₂ can react with 1) aromatic compounds (e.g., benzene) to form phenol and CO, 2) olefins to form epoxides and CO, or 3) olefins to form carboxylic acids (e.g., benzoic acid from styrene or adipic acid from butadiene. The substrate used to react with the activated CO₂ can be include in the process by mixing with the CO₂ feed stock or by adding separately in portions or by continuous addition.

Certain embodiments of the invention are directed to systems for CO₂ capture. In general aspects, stage 1 of a system for CO₂ capture includes moving a flowing mass of ambient air having the usual relatively low concentration of CO₂ in the atmosphere, with a relatively low pressure drop (in the range of 100-1000) pascals. The flow of CO₂ containing air from Stage 1, can be passed, in Stage 2, through a large area bed, or beds, of sorbent (e.g., including MCN-TU) for the CO₂, the bed having a high porosity and on the walls defining the pores a highly active CO₂ adsorbent.

According the other embodiments, include systems for CO₂ capture and activation to form a reaction product. Referring to FIGS. 2 and 3, systems are illustrated, which can be used to capture CO₂ using the MCN-TU material of the present invention and/or activate the CO₂. The system 22 can include a feed source 24, a separation unit 26. The feed source 24 can be configured to be in fluid communication with the separation unit 26 via an inlet 28 on the separation unit. The feed source can be configured such that it regulates the amount of CO₂ containing material entering the separation unit 26. The separation unit 26 can include at least one separation zone 30 having the MCN-TU material 32 of the present invention. Although not shown, the separation unit may have additional inlets for the introduction of gases that can be added to the separation unit as mixtures or added separately and mixed within the separation unit. Optionally, these additional inlets may also be used as an evacuation outlet to remove and replace the atmosphere within the separation unit with inert atmosphere or reactant gases in pump/purge cycles. To avoid the need to remove atmosphere from the separation unit, the entire separation unit can kept under inert atmosphere. The separation unit 26 can include an outlet 34 for uncaptured gases in the separation unit. The separation unit can be depressurized or chemically treated to remove the desorbed or bound CO₂ from the MCN-TU material. A second unit can be used in combination with separation unit 26 to provide a continuous process. The released CO₂ can exit the separation unit from outlet 36 and be collected, stored, transported, or provided to other processing units for further use.

Referring to FIG. 3, system 40 is system used to activate CO₂ for use in producing alcohols or carbonylated materials. Reactor 42 can include MCN-TU material 44 in reaction zone 46. CO₂ can enter reactor 42 via inlet 48 and an olefinic (e.g., olefin, substituted olefin, aromatic, substituted aromatic compound) can enter reactor 42 via inlet 50. The CO₂ and olefinic material can mix in reactor 42 to form a reactant mixture. In some embodiments, the CO₂ and olefinic material can be provided as one stream to reactor 42. In reaction zone 46 as the CO₂ and olefinic material pass over the MCN-TU material, the basic nitrogen sites on the MCN-TU material can activate or bond to the CO₂ and promote addition of an oxygen and/or a CO to the olefinic compound. By way of example, CO₂ and benzene can be contacted with the MCN-TU material to produce phenol and CO. The reactor 42 can be heated under desired pressures and temperatures to promote the reaction of CO₂ with the olefinic material. The reaction product can exit reactor 42 via product outlet 52 and be collected, stored, transported, or provided to other units for further processing. If necessary, the reaction product can be purified. For example, unreacted CO₂ and olefinic compound can be separated (e.g., separation system 22) and recycled to reactor 42. Systems 22 and 40 can also include a heating source (not shown). The heating source can heaters, heat exchange systems or the like, and be configured to heat the reaction zone 42 or separation zone 4 to a temperature sufficient to perform the desired reaction or separation.

The relatively low concentration of CO₂ in the air (as opposed to effluent gases), requires a strong sorbent. In some aspects, the MCN-TU material of the current invention can include a primary amine group and/or secondary amine groups. The primary amine groups can be effective at temperatures in the range of from about 10-25° C. for capturing CO₂ and/or activating CO₂. By utilizing all primary amine groups, especially in the form of polymers, one can maximize CO₂ loading. Primary amines have a heat of reaction of 84 Kj/mole with CO₂, which indicates stronger bonds, while the secondary amines have a heat of reaction of 73 Kj/mole. Notably without limitation, at lower temperatures (e.g., −10 to +10° C.) secondary amines can be effective to capture and/or active CO₂. The loading of CO₂ can depend upon the ratio of the heat of reaction/K (Boltzmann constant) T (temperature). The heat of reaction difference between primary and secondary amines can result in a factor of about 100 times difference in loading, following the Langmuir isotherm equation. The primary amine and/or secondary amine containing MCN-TU material of the present invention can work effectively at air capture (from atmospheric air) concentrations under ambient conditions.

In another non-limited aspect, the MCN-TU material of the present invention contains enhanced sensing properties. MCN-TU can be included in a C₁₋₂ hydrocarbon acid sensor, such as for detecting formic acid, acetic acid, or both. In another aspect, MCN-TU can be used as a biosensor and filled with a fluorescent dye that would normally be unable to pass through cell walls. The MCN-TU material can then be capped off with a molecule that is compatible with the target cells. When the capped MCN-TU material are added to a cell culture, they can carry the dye across the cell membrane. In some instances, the MCN-TU material can be optically transparent, so the dye can be seen through the silica walls. Encapsulating the dye within the MCN-TU material can inhibit self-quenching of the dye.

In a non-limiting aspect, MCN-TU has good photoluminescence and can be used as a photocatalyst in a photocatalytic process for producing hydrogen gas (H₂) from water in a water-splitting reaction. The process can include (a) contacting the mesoporous material with water to form a reactant mixture; and (b) exposing the reactant mixture to light (e.g., sunlight, visible light, or a combination thereof) to form hydrogen gas from the water. The produced hydrogen gas can be purified and/or stored and/or used direction in subsequent reactions (e.g., hydrogenation reactions). Without wishing to be bound by theory, it is believed that the three dimensional 3-amino-1,2,4-triazole based mesoporous carbon nitride matrix material fulfills the three main requirements for a water splitting photocatalyst of: (i) an oxidative active site for the oxygen evolution, (ii) a reductive site for the hydrogen generation, and (iii) a good semi-conductor for the photon absorption.

In some embodiments, a sacrificial agent can be added to the reactant mixture. The presence of the sacrificial agent can increase the efficiency of the photosystem by further reducing the likelihood of hole/electron recombination via oxidation of the sacrificial agent by the hole rather than recombination with the excited electron and/or assist in photodeposition of the co-catalyst on the MCN-TU surface. Non-limiting examples of sacrificial agents that can be used in the methods of the present invention include ethanolamines, alcohols, diols, polyols, dioic acids, or any combination thereof. A non-limiting examples of particular sacrificial agent includes triethanolamine, or any combination thereof.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

Materials. Tetraethyl orthosilicate (TEOS), 3-amino-1,2,4-triazole (3-AT), urea, n-butanol, and triblock copolymer poly(ethylene glycol)-block-poly(propylene glycol)-block-poly(ethylene glycol) (Pluronic P-123, molecular weight 5800 g mol⁻¹, EO₂₀PO₇₀EO₂₀) were obtained from commercial sources, such as TCI (U.S.A) and Sigma-Aldrich® (U.S.A). Ethanol and hydrofluoric acid (HF) were purchased from Wako Pure Chemical Industries (U.S.A.). All the chemicals were used without further purification. Doubly deionized water has been used throughout the synthesis process.

### Example 1

### Preparation of Mesoporous 3D KIT-6 Silica Template with Different Pore Diameters

KIT-6 having different pore diameters was synthesized by using a P123 and n-butanol mixture as the structure directing agent at different synthesis temperatures. In a typical synthesis, P123 (4.0 g) was dispersed in a water (144 g) and HCl solution (7.9 g), and stirred for 3 hours at 35° C. to obtain an aqueous P-123 homogeneous solution. 1-Butanol (4.0 g) was added to the aqueous P-123 homogeneous solution and the mixture was stirred for a further 1 hour. TEOS (8.6 g) is then added and stirring was continued at 35° C. for 24 hours to produce a reaction mixture. Subsequently, the reaction mixture was aged at 100° C. for 24 h under static conditions. At these conditions a white solid product was formed. The white solid product was filtered without washing under hot conditions and dried at 100° C. for 24 hours in an air oven. Finally, the product was calcined at 540° C. in air to decompose the triblock copolymer. KIT-6 silica template materials with different pore diameters were synthesized at the synthesis temperatures of 100, 130, and 150° C. The samples were labeled KIT-6-X, for which X denotes the synthesis temperature.

### Example 2

### (Synthesis of 3-Amino-1,2,4-Triazole and Urea Based c-MCN Materials (MCN-TU-X) with Different Pore Diameters)

MCN-TU-X materials with three dimensional body centered cubic porous structure and various textural parameters were prepared by using 3D mesoporous silica KIT-6-X having various pore diameters as templates. Calcined KIT-6-X (1 g, X=100° C., 130° C., 150° C.) was thoroughly mixed with the solution obtained by dissolving 3-amino-1,2,4-triazole (3.0 g) and urea (3.0 g) in deionize water (DI) water (4-5 g) with conc. HCl (0.168 g). The mixture was placed in a drying oven for 6 hours at 100° C. and carbonized in a step-wise manner. The dried material was heated to 160° C. and maintained there for another 6 hours and then heated at 500° C. under inert atmosphere to produce a carbonized composite. The carbonized composite was treated with HF (5 wt. %) at room temperature to dissolve the silica template. The obtained template free MCN-TU-X was filtered, washed several times with ethanol, and dried at 100° C.

### Example 3

### Characterization of MCN-TU-150

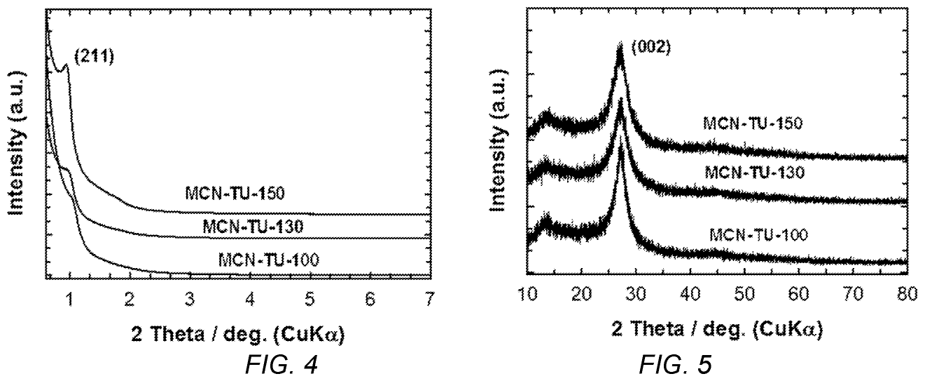

XRD: Powder XRD patterns were recorded on a Rigaku Ultima+(JAPAN) diffractometer using CuKα (λ=1.5408 Å) radiation. Low angle powder x-ray diffractograms were recorded in the 20 range of 0.6-6° with a 2θ step size of 0.0017 and a step time of 1 sec. In case of wide angle X-ray diffraction, the patterns were obtained in the 20 range of 10−80° with a step size of 0.0083 and a step time of 1 sec. FIG. 4 shows the low angle powder XRD patterns of MCN-TU-X of the present invention. FIG. 5 is a wide angle powder XRD pattern of MCN-TU-X of the present invention.

The XRD pattern of the MCN-TU showed a well resolved peak with several weak higher order reflections. The highly intense peak was indexed to (211) reflection of the cubic type Ia3d structure, almost similar to the parent mesoporous silica template, KIT-6. The unit cell parameter from the (211) reflection was measured to be 23.24 nm for MCN-TU-150, which was slightly lower than that of the parent template. From the XRD it was determined that the MCN-TU possesses 3D cubic structure with an enantiomeric system of independently interpenetrating continuous network of meosporous channels. The crystallinity and graphitic character of the mesoporous wall structure, the MCN-TU material was characterized by wide angle XRD analysis (FIG. 5). FIG. 5 shows a more pronounced diffraction peak at 20=27.2 for MCN-TU-150°, corresponding to an interlayer d-spacing of 3.27 Å, which was indexed to the (002) reflection of the pure graphitic lattice, thereby confirming the turbostratic ordering in the wall structure. The large intensity of the (002) reflection was attributed to the graphitic ordering (partial crystallinity) in the pore walls. In addition, weak peak at 13.2° (d spacing=6.68 Å) was attributed to the in-plane structural packing motif.

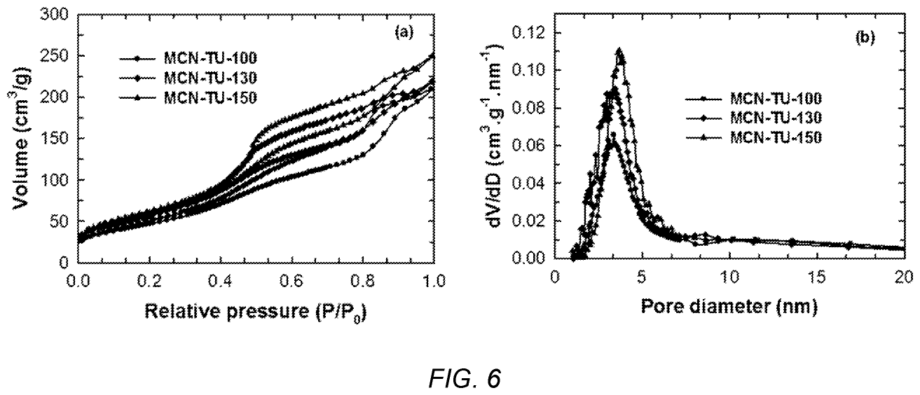

Textural parameters. Textural parameters and mesoscale ordering of the MCN-TU material was confirmed by nitrogen adsorption/desorption measurements using a Quantachrome Instruments (U.S.A.) sorption analyzer at −196° C. All samples were out-gassed for 12 hrs at high temperatures under vacuum (p<1×10-5 h·Pa) in the degas port of the adsorption analyzer. The specific surface area was calculated using the Brunauer-Emmett-Teller (BET) method. The pore size distributions were obtained from either adsorption or desorption branches of the isotherms using Barrett-Joyner-Halenda (BJH) method. FIG. 6 shows the N₂ adsorption-desorption isotherms of the MCN-TU-100, MCN-TU-130, AND MCN-TU-150 materials. The isotherm was of type IV according to IUPAC classification and with characteristic capillary condensation or evaporation step, which indicated the presence of a well-ordered mesoporous structure. MCN-TU showed narrow pore size distribution centered at 3.42 nm (FIG. 5). Specific surface area (S_{BET}), pore volume (P_{V}) and pore diameter (P_{D}) values of the MCN-TU-X materials.

TABLE 1

| | a₀ | A_{BET} | Pore volume | Pore diameter |
|---|---|---|---|---|
| Sample | [nm]^{a} | (m² · g⁻¹) | [cm³ · g⁻¹]^{b} | [nm]^{c} |
| MCN-TU-100 | 20.78 | 176 | 0.29 | 3.37 |
| MCN-TU-130 | 22.28 | 214 | 0.31 | 3.43 |
| MCN-TU-150 | 23.24 | 220 | 0..35 | 3.66 |

^{a}The cell parameter calculated from low-angle XRD patterns (FIG. 1) using a₀ = \sqrt{6}*d₂₁₁
^{b}Total pore volumes estimated from the adsorbed amount at a relative pressure of p/p0 = 0.99.
^{c}Pore diameters derived from the adsorption branches of the isotherms by using the BJH method.

Chemical analysis. Chemical analysis was carried out by using a Yanaco MT-5 CHN elemental analyzer (Yanaco Bunseki Kogyo Co., JAPAN) and are presented in Table 2. The atomic carbon to nitrogen ratio of the material was found to be about 0.71. The high nitrogen content detected in the sample, as compared with the ideal C₃N₄ (ca. 0.73) structure, was attributed to the increased number of amine groups and/or urea groups in the MCN-TU material.

TABLE 2

| Element | Atomic ratio | Percent content | C/N ratio |
|---|---|---|---|
| C | 0.71 ± 0.101 | 40.74 | 0.71 |
| N | 1.00 ± 0.000 | 57.09 | |
| O | 0.04 ± 0.007 | 2.17 | |

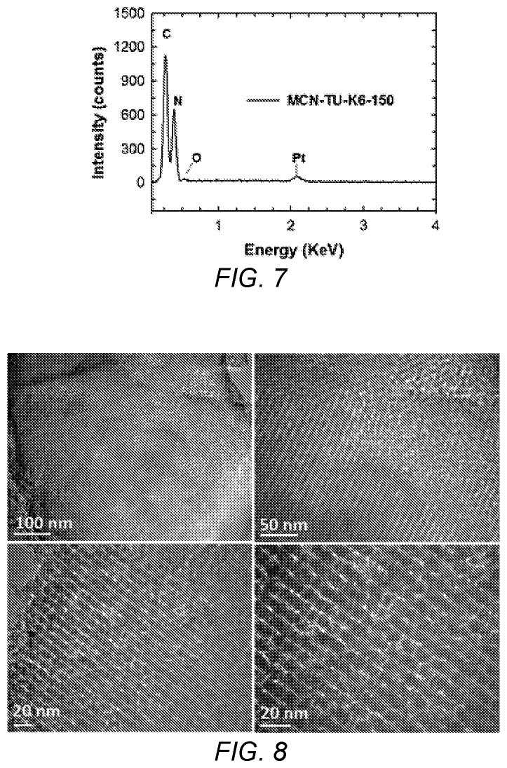

EDX. EDX analysis was performed using a Hitachi S-4800 (U.S.A.) field emission scanning electron microscope (FE-SEM) equipped with energy dispersive X-ray (EMAX) elemental analyzer. Prior to observation, all the samples were sputtered with Pt for 20 sec by using ion coater. Samples were measured under the accelerating voltage of 5-10 kV, emission current around 10 mA condensed lens of 5 Megapixel. During elemental analysis (EDX), aperture number 1 with working distance around 15 mm was used. EDX along with elemental mapping were recorded on the same machine using accelerating voltage of 15 kV. FIG. 7 shows the Energy Dispersive X-Ray (EDX) spectrum of MCN-TU-150. Peaks for the elements C, N, O were identified in the EDX spectrum. The absence of the signals at Si or F positions indicated effective silica removal by strong acid, HF. The weight and atomic percent of surface carbon, nitrogen and oxygen are listed in Table 3 from which it was determined that the MCN-TU-150 had an atomic C/N ratio of (about 0.55).

TABLE 3

| Element | Weight % | Atomic % |
|---|---|---|
| Surface C | 31.79 | 35.27 |
| Surface N | 66.93 | 63.67 |
| Surface O | 1.27 | 1.06 |

HRTEM and EELS: HRTEM images were obtained using a JEOL-3100FEF (JOEL, U.S.A.) high-resolution transmission electron microscope, equipped with a Gatan-766 electron energy-loss spectrometer (EELS). The preparation of the samples for HRTEM analysis involved sonication in ethanol for 5 min and deposition on a copper grid. The accelerating voltage of the electron beam was 200 kV.

FIG. 8 shows the TEM images of MCN-TU at various magnifications. Well-ordered arrays of pore channels were observed. From the images, it was determined that pore size and connectivity of the material exactly reflected the geometric properties of the original template, KIT-6.

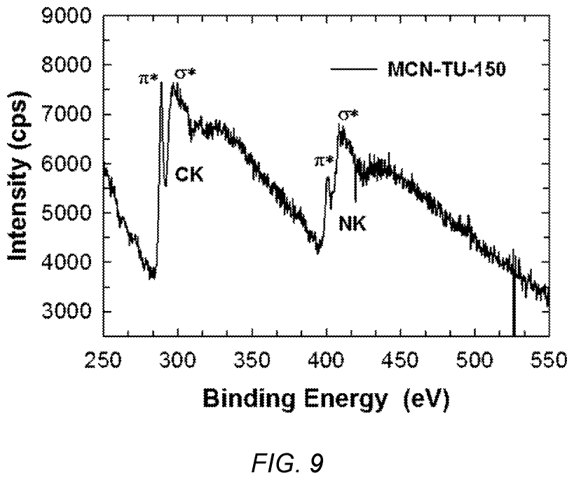

FIG. 9 shows the electron energy loss spectrum (EELS) recorded for MCN-TU-150 sample. The sample exhibited identical, well resolved carbon K-ionization and nitrogen K-ionization edges located at 284 eV and 401 eV, respectively, which indicated a similar electronic environment of C and N in the material. The peak at 284 eV was due to 1s-π* electron transitions which indicate the presence of sp² hybridized carbon bonded to nitrogen while the signal at 401 eV was assigned to the sp² hybridized nitrogen atoms which were present with carbon atoms in the wall structure. From the spectrum, it was clear that the MCN-TU-150 framework was entirely composed of C and N atoms and no impurities were detected. However, the presence of oxygen was below the detection limit, which supported the fact that trace amounts of oxygen found in EDX analysis cannot be recognized as intrinsic components of the product and the origin of oxygen may point towards atmospheric moisture or adsorbed CO₂ or H₂O that would have likely been removed under the electron beam irradiation and high vacuum conditions of the electron microscope.

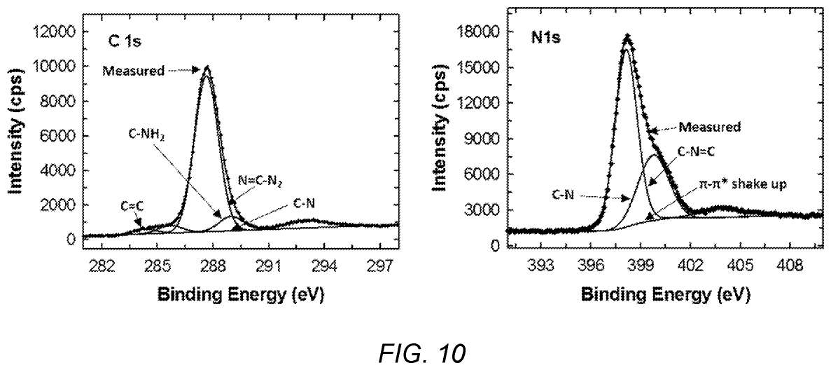

XPS. XPS spectra of the MCN-TU sample was obtained using a PHI Quantera SXM (ULVAC-PHI, JAPAN) instrument with a 20 kV, Al Kα probe beam (E=1486.6 eV). Prior to the analysis, the samples were evacuated at high vacuum (4×10−7 Pa), and then introduced into the analysis chamber. For narrow scans, analyzer pass energy of 55 eV with a step of 0.1 eV was applied. To account for the charging effect, all the spectra were referred to the C1s peak at 284.5 eV. Survey and multiregion spectra were recorded at C1s and N1s photoelectron peaks. Each spectral region of photoelectron interest was scanned several times to obtain a good signal-to-noise ratio. FIG. 10 shows the XPS spectra of the MCN-TU-150 material.

FT-IR spectra. FT-IR spectra of the MCN-TU material was obtained using a Perkin Elmer (U.S.A.) spectrum 100 series, bench top model equipped with the optical system that gives the data collection over the range of 7800 to 370 cm-1. The spectra were recorded by averaging 200 scans with a resolution of 2 cm-1, measuring in transmission mode using the KBr self-supported pellet technique. The spectrometer chamber was continuously purged with dry air to remove water vapor. FIG. 11 shows FT-IR spectrum of the MCN-TU-150 material.

TDP. In order to measure the number and strength of basic sites on the MCN-TU-150, as evidenced from XPS and FT-IR, temperature programmed desorption (TPD) of carbon dioxide (CO₂) was performed on the MCN-TU sample using a Micromeritics® AutoChem II 2920 (Micromeritics®, USA) fully automated chemisorption analyzer equipped with gold-plated filament. The system consists of adjustable oven to heat the sample and gas mixture supplier for different gases. The measurements can be carried out from ambient to 1100° C. temperature range. In the present study, high purity carbon dioxide gas was used as a probe gas. About 80 mg of the samples were evacuated for 3 hrs at 250° C. under vacuum. Then samples were cooled to room temperature followed by CO₂ adsorption for 30 min. The physisorbed CO₂ was removed by heating the sample to 120° C. for 2 hrs. Desorption of chemisorbed CO₂ was performed in the temperature range of 120-500° C. with a rate of 5° C./min using a TCD detector.

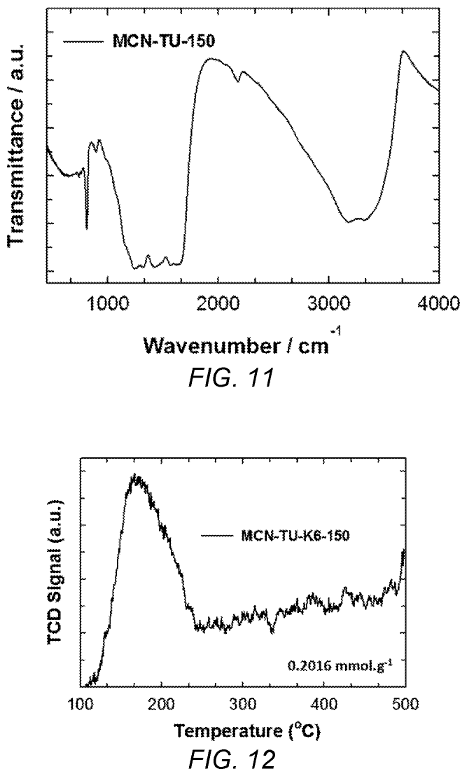

FIG. 12 shows the profile for CO₂ desorption from MCN-TU-150 material. Broad desorption peak centered at 166.2° C. was observed. Table 4 lists the data from the profile.

TABLE 4

| | Temp. at | Quantity | Peak |
|---|---|---|---|
| Peak No. | max. (° C.) | (cm²/g) | Concentration (%) |
| 1 | 166.2 | 4.52 | 0.04 |

Since the area under the peak is proportional to the density of CO₂ molecules adsorbed (i.e., proportional to the surface coverage) on the surface of the sample, it was evident that the sample adsorbed a moderate amount of CO₂ molecules (0.202 mmol/g) on its surface. Such a considerable adsorption of CO₂ molecules was attributed to the existence of more number of basic sites (—NH₂, —NH— groups) on the surface of the sample. This acid-base interaction play important role in the chemisorption of the acidic molecules on the basic catalyst surface. Another factor responsible for the CO₂ adsorption was the high specific surface area and three-dimensional structure of the MCN-TU, which provided enough exposure to more number of active basic sites.

### Example 4

### (Quartz Crystal Microbalance (QCM) Study)

### A. General Procedures

Quartz Crystal Microbalance. A QCM technique was used for detection of mass change during the assembly process. In order to act as electrodes, the QCM resonators (USI System, Japan) used were coated by vapor deposition with silver on both surfaces. The resonance frequency was 9 MHz (AT-cut) and frequency decreased (−ΔF) proportionally with increase in mass (Δm) according to the Sauerbrey equation. Using intrinsic parameters for AT cut quartz plate and electrode area, the equation Δm (Hz)=0.95×(−ΔF) (ng) holds. The frequency of the resonators was measured for adsorption step and the frequency was recorded when it became stable. The QCM frequency in air was stable within ±2 Hz during 1 hour. All experiments were carried out in an air-conditioned room at 25° C.

QCM Vapor Adsorption. For measuring the vapor adsorption, solvents (10 ml) in the 15 ml petri dish was kept into the trough in an QCM instrument in an air-conditioned room at 25° C. The QCM resonators with samples were then fixed in the QCM instrument. The QCM instrument was covered with a full side cover to prevent the vapor from leaking during the in situ adsorption measurement.

### B. Sensor Evaluation

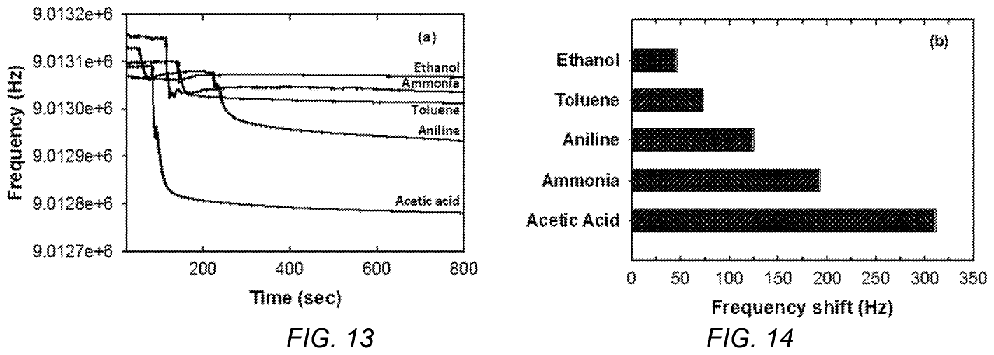

The MCN-TU-150 material was analyzed as a sensor. FIG. 13 displays the typical response patterns obtained from the QCM sensor when the MCN-TU sample is exposed to volatile organic compounds such as aromatic hydrocarbons (toluene, aniline), acidic solvent (acetic acid, formic acid), alkaline solvent (ammonia). Frequency shifts for different analytes and total frequency shift are depicted in bar graph (FIG. 14). Different amplitudes of frequency shift were observed for different guest molecules. However, frequency shift for the toxic formic acid and acetic acid molecules was larger as compared with other guests despite their very similar vapor pressures and molecular weights, indicating the higher sensitivity and selectivity of MCN-TU sample towards acidic solvent. First rapid frequency drop was attributed to the adsorption of guest molecules on the outer surface of the film and the subsequent frequency drop was due to the penetration (diffusion) of the vapor molecules from gas phase inside the porous channels of the sample. Such a large selective adsorption of toxic acetic acid molecules was believed to due to the following two rationales. First, from the TPD spectrum of MCN-TU (FIG. 12) it was determined that the presence of increased numbers of active Lewis basic sites (—NH₂, —NH) on the surface of the catalyst. This led to the sorption of acidic molecules through acid-base interaction. Second, the three dimensional structure with large specific surface area is believed to offers widely opened spaces and access to an increased number of basic sites for the guest-host interaction.

In summary, the current invention describes for the first time, the synthesis of highly ordered 3D mesoporous carbon nitride material from 3-amino-1,2,4-triazole and urea precursors using a 3D cubic Ia3d KIT-6 template. The precursors used are inexpensive and nontoxic. The material had a high specific surface area, tunable pore diameter, large pore volume, and the structural symmetry of the parent 3D cubic silica template KIT-6 was retained. The combination of these properties and their ease of formation provide an elegant material suitable for applications in absorption of bulky molecules and/or activation of CO₂.

1. A mesoporous carbon nitride (CN) material comprising a three dimensional C₃N₅ mesoporous carbon nitride polymeric material, said polymeric material comprising monomeric units of 3-amino-1,2,4-triazole and urea, said polymeric material having an atomic carbon to nitrogen ratio of 0.55 to 0.8 and basic nitrogen containing groups of between 0.15 to 0.25 mmol per gram.

2. The mesoporous material of claim 1, wherein the surface basicity is about 0.20 mmol per gram.

3. The mesoporous material of claim 1, wherein the atomic carbon to nitrogen ratio is about 0.70.

4. The mesoporous material of claim 1, wherein the material comprises at least 50% nitrogen.

5. The mesoporous material of claim 1, to wherein the material has an average pore diameter of 2 to 5 nm.

6. The mesoporous material of claim 1, wherein the material has a surface area of 170 to 250 m²/g, a pore volume of 0.2 to 0.4 cm³g⁻¹, or any combination thereof (currently amended) The mesoporous material of claim 1, wherein the material is a CO₂ activation catalyst.

8. A process for CO₂ capture, the process comprising:
(a) contacting the mesoporous material of claim 1, with a feed stock comprising CO₂ to form a reactant mixture; and
(b) incubating the reactant mixture under conditions in which CO₂ is attached to the mesoporous material.

9. The process of claim 8, wherein the CO₂ is further transformed into a reaction product.

10. The process of claim 8, wherein the feedstock is a gas effluent from a CO₂ producing process.

11. The process of claim 8, wherein the feedstock is a flue gas emission from a power plant.

12. The process of claim 8, wherein the feedstock is at ambient atmosphere.

13. The process of claim 8, wherein the CO₂ is desorbed from the mesoporous material.

14. A method of producing a mesoporous carbon nitride material of claim 1, the method comprising:
(a) mixing a hard template with equimolar amounts of 3-amino-1,2,4-triazole and urea (TU) in an acidic aqueous solution forming a template reactant mixture;
(b) heating the template reactant mixture to form a TU/template composite;
(c) heating treating the TU/template composite to a temperature of 450° C. to 550° C. to form a cubic mesoporous carbon nitride material/template (MCN-TU/template) complex; and
(d) dissolving the template from the cubic mesoporous carbon nitride material/template complex producing a three dimensional C₃N₅ mesoporous carbon nitride material having an atomic carbon to nitrogen ratio of 0.55 to 0.8 and basic nitrogen containing groups of between 0.15 to 0.25 mmol per gram.

15. The method of claim 14, wherein the heating of step (b) comprises:
heating to a first temperature of 90 to 110° C., preferably about 100° C.; and
increasing the temperature to 150 to 170° C., preferably about 160° C.

16. The method of claim 14, wherein the heating of step (c) is about 500° C.

17. The method of claim 14, wherein the MCN-TU/template complex is heated under an inert gas atmosphere.

18. The method of claim 17, wherein the inert gas is argon.

19. The method of claim 14, wherein the template is KIT-6, MCM-41, SBA-15, TUD-1, HMM-33 or mixtures thereof.

20. The method of claim 19, wherein the template is KIT-6.
